(19) United States
(12) Patent Application Publication
(10) Pub. No.: US 2004/0230335 A1
(43) Pub. Date: Nov. 18, 2004

(54) System for capturing shape data for eyeglass lenses, and method for determining shape data for eyeglass lenses

(76) Inventors: David W. Gerding, Barboursville, VA (US); Henrik A. Schutz, Troy, VA (US); Kenneth Van Cleave, Abilene, TX (US)

Correspondence Address: Joseph W. Berenato, III, Liniak, Berenato & White, LLC, 6550 Rock Spring Dr., Suite 240, Bethesda, MD, 20817, US

(21) Appl. No.: 10/436,224

(22) Filed: May 13, 2003

(51) Int. Cl. G06F 19/00; B24B 49/00

(52) U.S. Cl. 700/163; 451/5; 451/42

(57) ABSTRACT

An eyeglass lens or lens pattern shape capture system comprises a digitizer having a position indicator and a coordinate detecting surface. The digitizer generates positional data corresponding to the circumference of one of a lens and a lens pattern positioned on the detecting surface. A central processing unit is operably associated with the digitizer, and receives the positional data from the digitizer. An instruction set processes the positional data into trace data usable by an edger device.

### COMPUTER PROGRAM LISTING APPENDIX

A computer program listing appendix is submitted herewith on compact disc recordable (CD-R) as Appendix A, and the material thereon is incorporated herein by reference. Duplicate copies of Appendix A are provided as Copy 1 and Copy 2. Copy 1 and Copy 2 are identical.

The files contained on Copies 1 and 2 are as follows:

| File Name: | Size in Bytes: | Date of Creation: |
|---|---|---|
| 66C5-C0D1.dat | 3,200 | Jan. 29, 2003 |
| AutoStartup.bas | 2,193 | Dec. 04, 2002 |
| Clsbitmap.cls | 4,599 | Mar. 07, 2002 |
| ClsBitmapModule.bas | 2,526 | Oct. 16, 2002 |
| clsFTP.cls | 26,088 | Dec. 09, 2002 |
| DontShowMe.frm | 3,327 | Dec. 20, 2002 |
| DontShowMe.frx | 778 | Dec. 20, 2002 |
| EFQC.efqc | 3 | Jan. 23, 2001 |
| EmulatorCom.frm | 2,085 | Mar. 07, 2002 |
| EmulatorComSetup.frm | 36,116 | Dec. 04, 2002 |
| EmulatorComSetup.frx | 978 | Dec. 04, 2002 |
| FaxRegisterForm.frm | 41,987 | Jan. 29, 2003 |
| LICENSE.TXT | 1,357 | Dec. 19, 2002 |
| MessageFrm.frm | 1,643 | Mar. 09, 2002 |
| modHOTKEY.bas | 2,097 | Jan. 29, 2002 |
| MSSCCPRJ.SCC | 200 | Jan. 29, 2003 |
| MyTwain.bas | 52,255 | Jan. 29, 2003 |
| RadBias.dat | 3,200 | Dec. 26, 2001 |
| Registry.bas | 1,830 | Mar. 07, 2002 |
| sendkey.bas | 1,727 | Mar. 07, 2002 |
| systray.bas | 903 | Mar. 07, 2002 |
| TraceCap.dat | 4,050 | Nov. 13, 2001 |
| TraceCapProject.vbp | 1,958 | Jan. 29, 2003 |
| TraceCapProject.vbw | 1,071 | Jan. 29, 2003 |
| TraceDisplay.frm | 3,185 | Dec. 04, 2002 |
| TraceDisplay.frx | 778 | Dec. 04, 2002 |
| TraceDraw.frm | 9,389 | Oct. 16, 2002 |
| TraceDraw.frx | 55,650 | Oct. 16, 2002 |
| TwainCaptureForm.frm | 170,419 | Jan. 29, 2003 |
| TwainCaptureForm.frx | 209,971 | Jan. 29, 2003 |
| TwainConfig.bas | 12,774 | Dec. 20, 2002 |
| TwainfrmAbout.frm | 11,487 | Dec. 04, 2002 |
| TwainfrmAbout.frx | 28,778 | Dec. 04, 2002 |
| TwainModifyfrm.frm | 32,815 | Jan. 29, 2003 |
| TwainModifyfrm.frx | 29,664 | Jan. 29, 2003 |
| TwainRegisterFrm.frm | 16,880 | Dec. 19, 2002 |
| TwainRegisterFrm.frx | 40,840 | Dec. 19, 2002 |
| TwainScreenCalibrate.frm | 3,578 | Mar. 07, 2002 |
| TwainScreenCalibrate.frx | 19,077 | Mar. 07, 2002 |
| VWgetDir.frm | 2,862 | Dec. 04, 2002 |
| VWgetDir.frx | 778 | Dec. 04, 2002 |
| WinTabModule.bas | 37,562 | Nov. 14, 2002 |

### FIELD OF THE INVENTION

The present invention is directed to an eyeglass lens or lens pattern shape capture system. The system comprises a digitizer having a position indicator and a coordinate detecting surface, a central processing unit operably associated with the digitizer, and an instruction set. The digitizer generates positional data such as x and y coordinates corresponding to points on the circumference of one of a lens and a lens pattern positioned on the detecting surface. The central processing unit receives the positional data from the digitizer. The instruction set processes the positional data received by the central processing unit into trace data usable by an edger device. The invention also relates to a method for determining shape data of one of a lens and a lens pattern.

### BACKGROUND OF THE INVENTION

In the eyeglass industry, it desirable to provide lenses having different shapes and sizes to accommodate different eyeglass frames. Due to consumer preferences, the eyeglass frame industry has developed to the point where it produces thousands of new styles of frames every year, with each style being made in several sizes. As such, there may be hundreds of thousands of different styles and sizes of eyeglass frames in use or available in the trade at any one time.

Generally, eyeglass lenses start out as lens blanks having certain optical properties designed to correct one or more defects in a patient's vision. To fit a particular eyeglass frame with a lens, a retail optical or wholesale laboratory must shape and size the lens blank to fit the frame selected by the customer.

The lens blanks must be accurately edge-ground to the specific shape required by the selected frame. A precision fit of lens to frame for retention of the lens around its entire periphery must be achieved, and therefore the edging of lenses must be precise.

In some conventional edging techniques, the eyeglass frame manufacturer provides patterns shaped to match the shape of a particular frame. The patterns are then used as guides for conventional edge grinders. The pattern is placed in the edge grinder, a size adjustment is made, and as the pattern is rotated, a cam follower traces its perimeter shape, translating that shape into a continuously varying radial distance from the center of rotation of the pattern. The edge grinder traces the pattern and removes material from the periphery of the lens blank in accordance with the pattern, much like conventional key duplication except with rotation.

In addition to simply using a pattern as a guide, it is often desirable to generate information relating to size and shape of the lens needed for a particular frame (i.e. trace data), and subsequently transmit the trace data to the edge grinder. The edge grinder then processes the edge of the lens blank to create an edge profile that matches the trace data. The trace data may then be maintained for a particular patient's lens, or for a particular pair of frames. Actual lens blank grinding may then be effected either on the premises at which the trace data was collected, or sent out to a laboratory for edge processing.

Separate tracer devices may also reduce, or eliminate, the need for retailers and small eyeglass laboratories to maintain large inventories of patterns. It is a burden for the retailers and wholesale laboratories to maintain an accurate inventory of all patterns, which requires keeping track of them so that they can be quickly located when an order is received for a lens to fit a particular frame. Furthermore, a large amount of storage space is required for all of these patterns, especially if more than one of the same pattern is required. In addition, the shear number of patterns, along with their small size and similarities in shape, may lead to severe problems in handling and lead to costly errors or delays in the production of finished lenses. Therefore, it has become much more cost efficient and desirable to acquire trace data.

Various tracer devices are known in the art. For example, U.S. Pat. No. 6,243,960 to Andrews et al., the disclosure of which is incorporated herein by reference, discloses a tracer for tracing a lens mount of eyeglass frames, a lens or a lens pattern. Generally, such tracers have a clamp assembly for clamping the frames in place, and an engager having a projecting surface for tracing the bevel groove of the frames. As known in the art, the frames typically have a bevel groove extending around the frames inner circumference for receiving the edge of the lens. Trace data is thereby generated according to the position of the engager. Although such tracers provide some advantages in acquiring trace data, they are relatively expensive and can be complicated to operate, requiring a relatively high degree of skill by the technician. Furthermore, although such tracers may be adapted for tracing lenses or lens patterns, additional components are necessary.

Other methods of edge processing employ a computer system having lens shape data stored in a memory. The computer then communicates with an edging machine, which grinds the lens according to the selected data. Thus, such methods provide for a computerized pattern system. Although some advantages are achieved over a conventional pattern inventory, all of the patterns and information relating to frames must be maintained and updated in an extensive memory. Given thousands of new frame styles are manufactured each year, all having numerous sizes available to consumers, such methods do not provide a practical solution to maintaining lens and frame data. In addition, all of the data must be input into the computer system. Generally, the data is obtained by mechanically tracing the shape of a pattern provided by the manufacturer, using conventional techniques known in the art.

In another attempt to acquire trace data used for edge processing, the circumference of a lens or lens pattern is manually traced onto a template with a conventional ink pen. The tracing is then scanned into a software system using a conventional scanner associated with a computer, and the resulting data is stored in a computer memory. The computer then retrieves the stored data, and deciphers the size, shape, and object center coordinates by a series of complex steps for yielding trace lens object representation data. The trace data is then transmitted to a centralized processing unit. Thus, trace data may be obtained, but numerous steps are required, in addition to a scanner system.

Therefore, there is a need for a simplified system for tracing lenses and lens patterns, which is relatively inexpensive and easy to operate for someone having relatively little skill, but provides accurate trace data usable by an edger device.

### SUMMARY OF THE INVENTION

An eyeglass lens or lens pattern shape capture system comprises a digitizer having a position indicator and a coordinate detecting surface. The digitizer generates positional data corresponding to points on the circumference of one of a lens and a lens pattern positioned with a fixture on the detecting surface. A central processing unit is operably associated with the digitizer, and receives the positional data from the digitizer. An instruction set processes the positional data into trace data usable by an edger device.

A method for determining shape data of one of a lens and a lens pattern comprises the steps of: providing a digitizer having a position indicator and a coordinate detecting surface; positioning one of a lens and a lens pattern on the coordinate detecting surface; generating positional data by tracing with the position indicator around one of the lens and the lens pattern on the coordinate detecting surface; and processing the positional data into trace data usable by an edger device.

A method for processing shape data from a lens comprises the steps of: capturing a lens image having a circumference; calculating a center point of the image; calculating spaced radii values from the center point to the circumference; calculating smoothed radii values derived from the spaced radii values; and converting the smoothed radii values into trace data usable by an edger.

### BRIEF DESCRIPTION OF THE FIGURES

FIG. 1 is a schematic view of a shape capture system according to the present invention;

FIG. 2 is an elevational view of a stylus;

FIG. 3 is a perspective view of a digitizer and stylus having a collar;

FIG. 4 is an elevational view of a stylus having a collar;

FIG. 5 is a perspective view of a collar; and

FIG. 6 is a flowchart outlining process steps for a trace program according to the present invention.

### DETAILED DESCRIPTION OF THE INVENTION

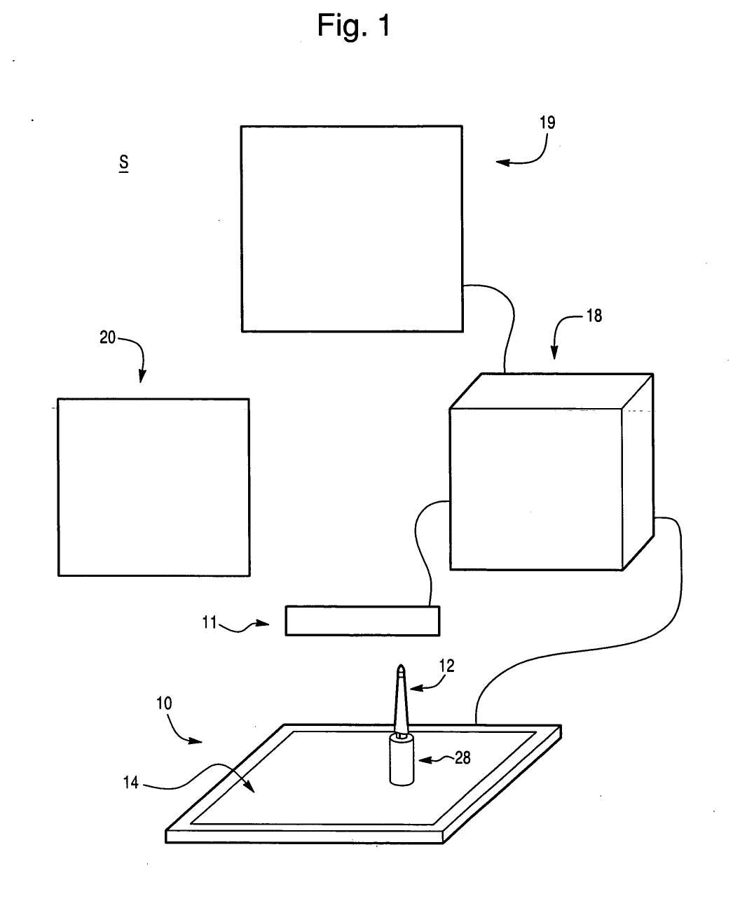

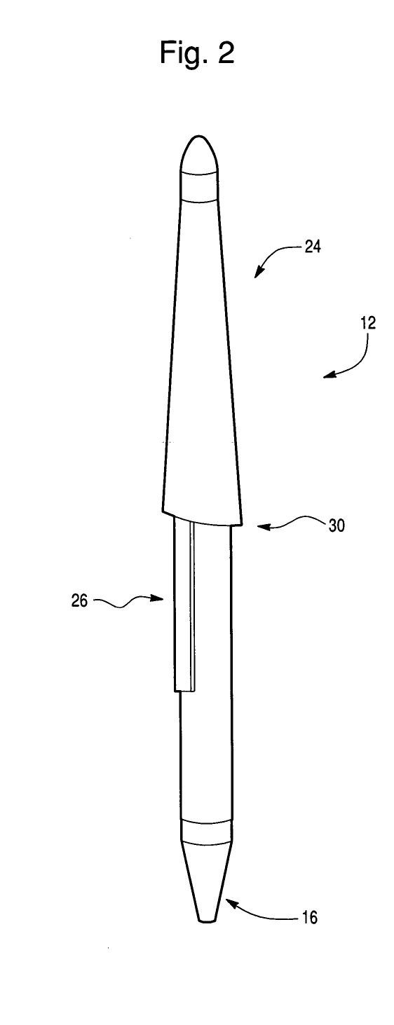

The present invention is directed to an eyeglass lens or lens pattern shape capture system S, as best shown in FIG. 1. Shape capture system S comprises an electromagnetic digitizer 10, such as a graphics tablet, having a position indicator 12 and a coordinate detecting surface 14. Preferably, position indicator 12 is a stylus having a tip 16, as best shown in FIG. 2. As known in the art, digitizer 10 generates positional data when tip 16 of position indicator 12 is located a predetermined distance from detecting surface 14. For example, position detection devices are disclosed in U.S. Pat. No. 4,878,553 to Yamanami et al., U.S. Pat. No. 5,693,914 to Ogawa, and U.S. Pat. No. 5,6345,684 to Fukuzak, the disclosures of which are all incorporated herein by reference. The assignee of these patents is Wacom Co., Ltd., which manufactures various types of digitizers suitable for use with shape capture system S of the present invention.

A central processing unit (CPU) 18 is operably associated with digitizer 10. CPU 18 receives the positional data from digitizer 10, and processes the positional data into trace data usable by an edger device 20. Edger device 20 may be directly connected to CPU 18. Alternatively, the trace data may be stored on a storage medium, such as a computer memory or disk, by CPU 18. The trace data may then be transferred to an off-site edger device 20 or other location. Edger device 20 may be any patternless edge processing apparatus known in the art. For example, an edger device is disclosed in U.S. Pat. No. 6,203,409 to Kennedy, the disclosure of which is incorporated herein by reference.

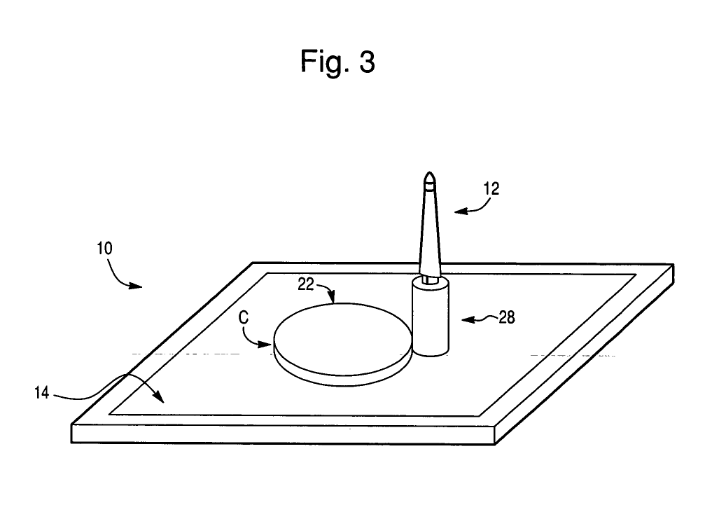

In order to acquire shape and size data of a lens 22, lens 22 or a lens pattern is positioned on detecting surface 14 of digitizer 10, as best shown in FIG. 3. The circumference C of lens 22 may then be traced with stylus 12. In order to ensure accurate positional data of circumference C, stylus 12 should be held substantially perpendicularly to detecting surface 14, as best shown in FIG. 3, and be maintained a predetermined constant distance from circumference C.

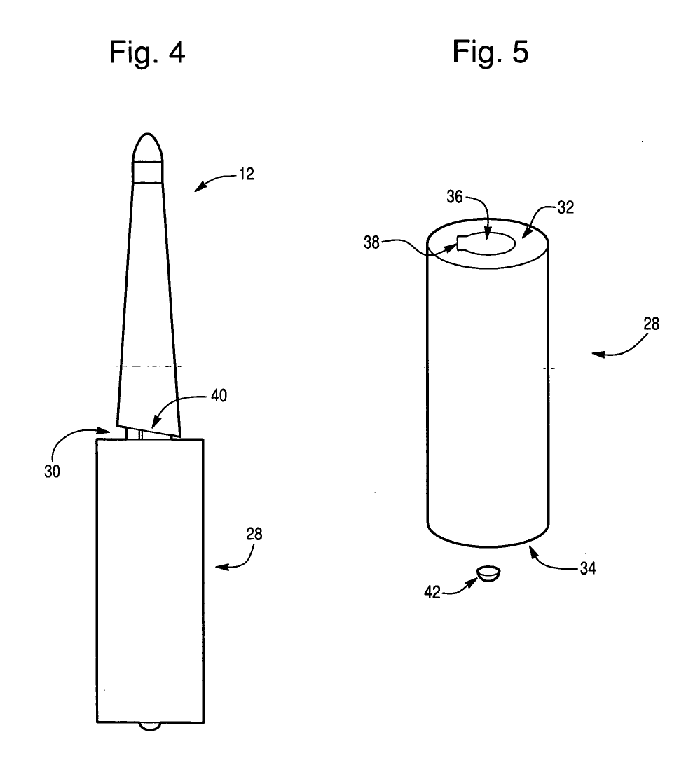

As best shown in FIG. 2, stylus 12 comprises an elongate body 24 with tip 16. Digitizer 10 includes a grid of electromagnetic wires, and cooperates with stylus 12 to locate the positional coordinates of tip 16 when tip 16 is within a predetermined proximity of detecting surface 14. Stylus 12 may also comprise a toggle button 26 for activating functions on an associated program running on CPU 18, as known in the art. In order to ensure an accurate tracing of lens 22, stylus 12 preferably includes a collar 28 that surrounds a portion of stylus 12, as best shown in FIGS. 1, 3 and 4. Collar 28 extends from an intermediate point 30 of elongate body 24 to a position adjacent tip 16, as best shown in FIG. 4.

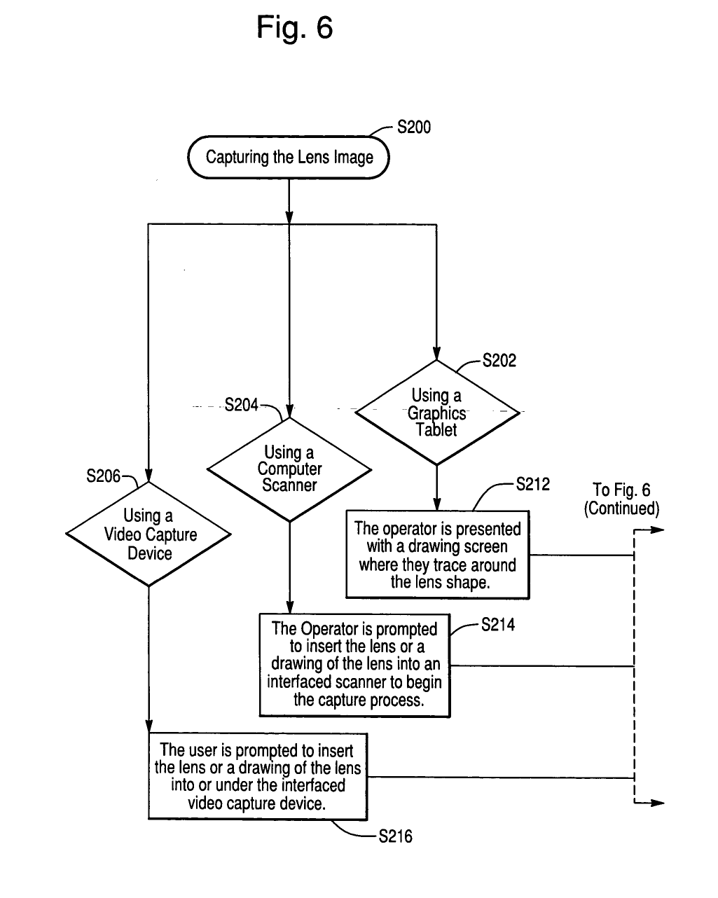

Collar 28 is preferably cylindrical with planar first and second ends 32, 34, as best shown in FIG. 5. Preferably, ends 32, 34 have diameters of about one inch. However, it should be understood that collar 28 may have a diameter either greater or less than one inch. An opening 36 extends from first end 32 to second end 34 through the entire length of collar 28. Opening 36 is adapted to receive elongate body 24 of stylus 12. Preferably opening 36 is also cylindrical, with a slot 38 for receiving button 26 on stylus 12. Stylus 12 may include a beveled edge 40 extending outwardly at intermediate point 30 of elongate body 24 to the end of stylus 12 opposite tip 16, as best shown in FIG. 4. Beveled edge 40 is wider than opening 36 on collar 28. Therefore, collar 28 is maintained in a position between tip 16 and beveled edge 40, and cannot “slide up” stylus 12 towards the end opposite tip 16. To further ensure that collar 28 is securely fitted onto stylus 12, a retaining end 42 may be fitted into opening 36 of second end 34, as best shown in FIG. 5. Tip 16 preferably protrudes from second end 34 of collar 28 by about 0.010 inches or less. However, tip 16 may also be flush with second end 34.

Using stylus 12 with collar 28, a user may accurately trace the perimeter of lens 22, thereby creating a locus of points which is a known distance from the perimeter of lens 22 by digitizer 10. Second end 34 is planar, as best shown in FIG. 4, and should remain flush with detecting surface 14 when tracing the circumference C of lens 22. If stylus 12 is held at an angle relative to detecting surface 12 during tracing, inconsistent positional data may be generated. Specifically, lens 22 has a certain thickness and curvature, which causes lens 22 to protrude from detecting surface 14. If stylus 12 is angled with respect to detecting surface 14 (i.e. not perpendicular), tip 16 of stylus 12 may not trigger positional data on detecting surface 14 at points corresponding to circumference C of lens 22. By using stylus 12 with collar 28, tip 16 maintains a predetermined constant distance from circumference C of lens 22 when stylus is perpendicular to circumference C and second end 34 is flush with detecting surface 14. In this way, precise positional data is generated.

The thickness and curvature of lens 22 do not affect the position of tip 16 when stylus 12 is perpendicular to circumference C of lens 22 during tracing. Tip 16 is maintained at a predetermined distance from lens 22 based on the known dimensions of collar 28, thus generating accurate positional data, given the surface of second end 34 is planar and relatively wide (1 inch in diameter) compared to tip 16.

As best shown in FIG. 3, lens 22 is preferably positioned in the physical center of detecting surface 14 of digitizer 10 when tracing circumference C of lens 22 using stylus 12 (having collar 28). Measurement points (i.e. positional data having x,y coordinate values) are generated by digitizer 10 when tip 16 is proximate detecting surface 14 during tracing, as known in the art. After tracing lens 22, the measurement points generated by digitizer 10 are communicated to CPU 18 via conventional means known in the art. Preferably, at least 400 measurement points are generated, whereby each measurement point indicates a detected position having x,y coordinates on detecting surface 14. However, it is possible that more than 400 measurement points will be generated by digitizer 10 during tracing, depending on the digitizer 10 being used, and the speed at which the user traces around lens 22. As such, fewer than 400 measurement points may also be generated, in which case the user may be alerted of insufficient positional data on a display 19 operably associated with CPU 18, as best shown in FIG. 1. If an insufficient number of measurement points are generated, the user may be requested to re-trace lens 22. It should be understood that although at least 400 measurement points are preferably generated, the user may select and/or adjust a minimum number of measurement points required for proceeding with the calculations without the necessity of re-tracing.

After a sufficient number of measurement points are generated, a geometric center of lens 22 is determined. The geometric center is determined based on four measurement points, including the measurement points having the largest x-axis value and smallest x-axis value (“horizontal measurements”), and the measurement points having the largest y-axis value and smallest y-axis value (“vertical measurements”). The horizontal and vertical measurements are used to form a box that exactly encompasses the shape of lens 22 (“horizontal and vertical box measurements”). The center of the “box” (based on the horizontal and vertical measurements) is located at the intersection of diagonal lines of opposite corners. Alternatively, the center of the box may be determined at the intersection of perpendicular lines taken from midpoints of opposing sides. This box center is the geometric center.

Using the geometric center as a reference point, 400 equally spaced radii points are determined from the geometric center. Adjacent spaced radii points form an angle of 0.9 degrees, since the radii points are equally spaced around 360 degrees (360°/400=0.9). Lines radiating from the geometric center every 0.9 degrees form radii angle lines. These angle lines either intersect measurement points, or pass between adjacent measurement points (which are therefore the two closest measurement points to the angle line). If an angle line passes between two measurement points, a point intermediate the these two closest measurement points is interpolated. In this way, 400 spaced radii points located around circumference C are determined, wherein each spaced radii extends from the geometric center to either a measurement point or an interpolated point. If two measurement points are intersected by an angle line, the point closer to the geometric center is used as the spaced radii point.

After 400 equally spaced radii are determined, “smoothed radius values” are determined for the entire circumference C of lens 22. Specifically, points located between adjacent spaced radii points are interpolated by averaging the two adjacent spaced radii values, thereby determining an intermediate radii point and length of the intermediate radius. Thus, additional points defining circumference C are determined. Thus, any non-measured points, or gaps between adjacent spaced radii points, are assigned values. This smoothing routine eliminates a “saw tooth” effect of radii values around circumference C, which is caused by less than perfect images generated by digitizer 10, or gaps between spaced radii points. Thus, the image is smoothed using an averaging routine. Preferably, spaced radii values undergo a maximum of six smoothing routines, which is pre-set in the program. If the data is processed by too many smoothing routines, the shape of the lens may become distorted because corners are continually rounded during smoothing. However, fewer or more smoothing routines may be applied depending on user preference.

After smoothed radii values are determined for the entire circumference C of lens 22, the radius of collar 28 must be taken into account. A mathematical routine is used to compensate for the effect of the diameter of collar 28. The smoothed radii points correspond to particular coordinates that are spaced from the actual circumference C of lens 22. Tip 16 generates positional data, but is spaced from the actual circumference C because of collar 28. Tip 16 is oriented in a center position of end 34 of collar 28. Therefore, the distance between tip 16 and the perimeter of end 34 of collar 28 (which is in contact with circumference C of lens 22 when tracing) is equal to the radius of end 34. Thus, each measurement point must be adjusted using mathematical formulas to account for the radius of collar 28 or shape distortion will result. Calibration routines for adjusting the data are set forth in detail on compact disc in APPENDIX A. CPU 18 applies collar diameter compensation formulas to the smoothed radii values to eliminate the shape distortion that would normally be introduced by the diameter of collar 28. Each of the smoothed radii values is modified in a manner determined by collar diameter compensation formula. The known radius of end 34 of collar 28 are used along with several other factors.

In addition, the smoothed radii values are also converted into actual millimeter values using calibration values that are assigned to each smoothed radius value. The smoothed radii values are multiplied by a calibration value to convert radii values to millimeters. This calibration value is determined by tracing a circular pattern or lens having a known diameter, such as 58 mm. The geometric center is determined for this pattern as described above. Because the pattern is round, all of the radii values from the geometric center will be 29 mm (58 mm diameter/2=29 mm). Thus, distances on detecting surface 14 of digitizer 10 may be calibrated using radii lengths from the pattern as a reference. Preferably, digitizer 10 is calibrated when instruction set of the claimed invention is first installed in CPU 18, or whenever a new digitizer 10, stylus 12 or collar 28 is used. This compensates for any idiosyncrasies or scaling errors associated with a particular digitizer 10, stylus 12 or collar 28. The smoothed radii values are then converted into millimeter values, wherein each smoothed radii value corresponds to a particular calibration value. The calibration values may be stored in a memory in a calibration file, and thereafter retrieved by CPU 18 during normal operation. If system S of the present invention is used for multiple workstations, the calibration file may be unique to each workstation, given the workstations will have different digitizers 10 and styluses 12.

Thus, the calibration routines adjust the smoothed radii values so that precise trace data may be obtained. In addition, other useful data is obtained, such as horizontal and vertical box measurements, and angle measurements. This data may be manipulated to provide data corresponding to an inverse lens configuration, which may be helpful for providing trace data on a right lens even if the left lens was traced, and vice versa. It should be noted that precise trace data may be obtained for any size or shape lens by applying the smoothing and calibration routines disclosed herein. The smoothing and calibration routines are set forth in detail on compact disc in APPENDIX A. The computer code used for these mathematical manipulations is also provided in APPENDIX A.

The resulting trace data (i.e. the precise shape of lens 22) may then be displayed on display 19. Lens 22 is displayed in actual size. In addition, a menu may also be displayed on display 19, with various fields displayed thereon. The user may manually input any desired adjustments or manipulations to the trace data in the fields displayed on display 19 using either digitizer 10, or second input device 11, such as a keyboard, puck, mouse, or second digitizer. For example, the user may adjust the axis or size of the trace data, which provides an accurate display of the size and shape of lens 22. Adjustment of overall lens sizing may therefore be modified using a size adjustment field in the program. This field adjusts the calculated circumference C of all future shapes, either increasing or decreasing, by an exact amount specified by the user. The user may also rotate the shape of lens 22 being displayed, or change the horizontal and vertical box measurements. Other informational fields may include frame type, distance between lenses, lens material, and base curve. Such information is useful in the optical field, as known in the art.

The modified trace data and corresponding image of lens 22 are again displayed after user adjustment. The trace data may then either be stored in a memory or on a disk by CPU 18. Alternatively, the trace data may be communicated to a serial or other port operably associated with CPU 18 in a format that is usable by other optical software programs or interfaced optical equipments, such as edger 20.

In a second embodiment of the present invention, trace data may also be calculated from a bitmap image of an actual lens if an image of the lens is generated using a video capture device. The acquired bitmap image data is then processed by mathematical routines, as set forth in APPENDIX A. Specifically, a value is provided for determining a pixel color threshold that must be reached, in which case the pixel is detected as either black or white. A high pixel color value is detected as white. As the pixel color value decreases and goes below the predetermined threshold value, the pixel is detected as black. Mathematical routines are then used to further determine if this pixel is the edge of the lens shape in the bitmap data. The threshold value is an arbitrary value correlated to contrast and brightness levels of a particular image, as known in the art. The edge or circumference of the image is calculated using the center of the bitmap image data as a reference point. CPU 18 scans for active pixels in the bitmap image data to determine the circumference of the lens image. Radius values are then calculated using the detected edge of the lens image and the center of the bitmap image as a reference point. The resulting radii values are then subjected to smoothing and calibration routines as described above, resulting in precise trace data that may be stored or sent to an edger. The user may also make manual adjustments on axis and size, as in the first embodiment.

In a third embodiment, trace data may also be calculated from a bitmap image from a trace of a lens scanned by a conventional scanner. CPU 18 includes a TWAIN scanner interface to scan with a TWAIN-compliant scanner driver. As known in the art, TWAIN is an interface that directly acquires image data from an external source, such as a scanner, within an application that is already running. RBG images contain three color-planes: red, blue and green. Color intensity is measured by assigned values ranging from 0 to 255 with 255 representing pure white and 0 representing pure black. If the image is an RBG image, it is converted to a grayscale image, which has one color plane. Color intensity values are compared against a threshold value of preferably 150 during conversion to a grayscale image. The resulting grayscale values are then applied against a threshold value of around 60, thereby defining a black and white image. From this image, the edge of the bitmap image of a lens is determined as in the second embodiment (using the center of display 19 as a reference point), and trace data is then determined by applying smoothing and calibration routines as in the second embodiment. It should be understood that the preferred thresholds might be increased or decreased, depending on the equipment used and the image being scanned. A scroll bar may be displayed on display 19 for easy adjustment of threshold sensitivity, whereby adjustment of the scroll bar corresponds to an operation using digitizer 10 or additional input device 11.

In all of the embodiments described herein, a mathematical routine may be applied which produces trace data that has an inverse or mirror configuration to the shape of the actual lens 22 traced. Therefore, trace data may be obtained for a left lens, even if the right lens is traced, and vice versa. Smoothed and calibrated data comprising a lens image is subjected to a mathematical routine that flips the data about a vertical axis, as set forth in detail in APPENDIX A.

In addition, the trace data may be manipulated as desired by the user, or precise information may be determined from the trace data. For example, the length of a line between any two x,y coordinates may be easily determined. An angle defined by the center point, and two circumference C points may also be determined. Radian values may also be converted to degrees. Thus, various manipulations and determinations may be obtained from the trace data, pursuant to various mathematical routines set forth in APPENDIX A, which are useful in the optical field.

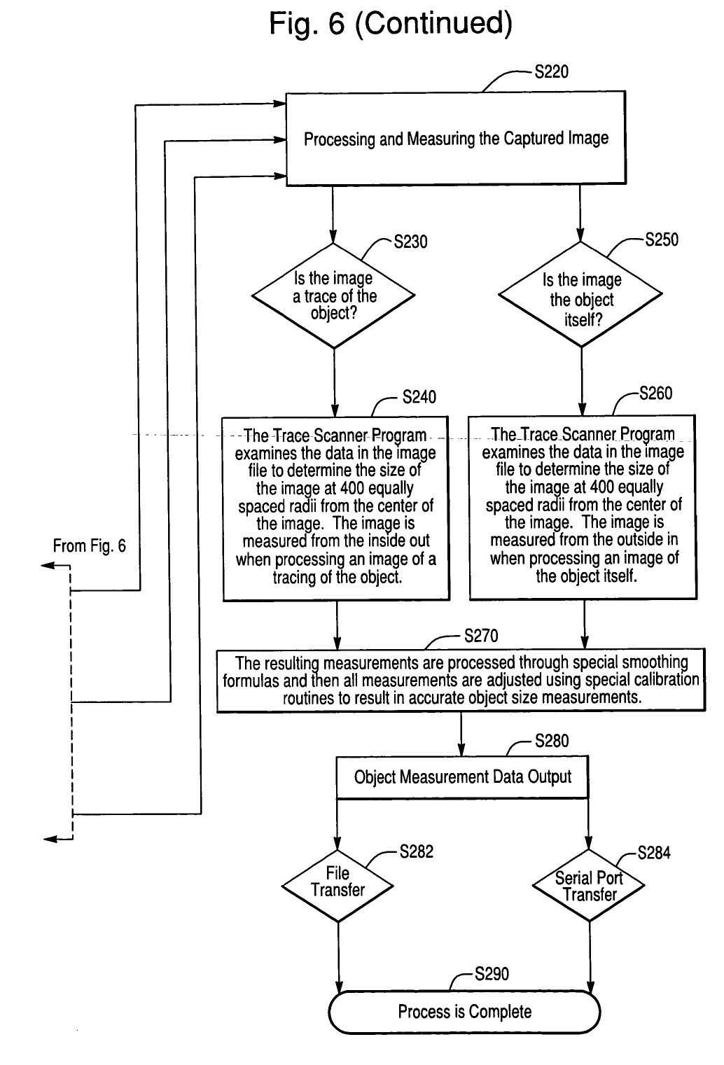

The process of obtaining trace data according to the present invention is outlined in FIG. 6 for all three embodiments disclosed herein. First, a lens image is generated, or captured, at S200. Specifically, the shape of the lens is captured either directly or indirectly through the use of a digitizer at S202, a computer scanner at S204, or a video capture device at S206, which are operably associated with CPU 18. The operator identifies the type of capture device that is being used in a program setup menu screen.

If a digitizer is used, the operator is presented with a drawing surface, such as detecting surface 14, on which the user traces around the lens shape at S212. If a computer scanner is used, the operator is prompted to insert the lens or a drawing of the lens into an interfaced scanner to begin the scanning process at S214. If a video capture device is used, the operator is prompted to insert the lens or a drawing of the lens into or under the interfaced video capture device at S216.

Next, the captured shape data (from either S212, S214, or S216) is subjected to processing and measuring routines at S220, as set forth in APPENDIX A. CPU 18 first determines if the shape data was obtained from an image of the lens at S230 (i.e. if a scanner or video image device were used). If yes, CPU 18 executes a program that examines the data in the image file to determine the size of the image using 400 equally spaced radii from the center of the image at S240. The image is measured from the center point to circumference points (i.e. from the inside out) when processing a tracing of the lens.

If the shape data was obtained from the actual lens itself at S250, CPU 18 executes a program that examines the data in the image file to determine the size of the image using 400 equally spaced radii from the center of the image at S260. However, the image is measured from the circumference points to the center point (i.e. from the outside in) when processing an image of the lens itself.

The resulting measurement points are then processed through smoothing routines, as described above. The smoothed radii values are then adjusted using calibration routines at S270. The resulting trace data may be displayed on a calibration screen at S280. Manual adjustments may be performed by the operator at S280, wherein adjustments are made to the calibration screen using an input device 10 or 11. The data may either be saved directly to a file at S282. Compatible programs and/or equipment may then import the trace data directly from the file. Alternatively, the data may be saved to a file, and transmitted to a user selectable serial port at S284, which may be interfaced to compatible programs or equipment, such as edger 20. After saving and/or transferring the data, the process is complete at S290

The disclosed program collects and manipulates image or measurement data received from an interfaced image capture device to find the edge of the object. The resulting data may be manipulated, output, and/or saved for future use. Furthermore, a program manager allows the user to view, delete, rename and alter previously stored shapes.

It will be apparent to one of ordinary skill in the art that various modifications and variations can be made in construction or configuration of the present invention without departing from the scope or spirit of the invention. Therefore, it is intended that the present invention cover all modifications and variations of the present invention, provided they come within the scope of the following claims and their equivalents.

We claim as follows:

1. An eyeglass lens or lens pattern shape capture system, comprising:
a digitizer having a position indicator and a coordinate detecting surface, said digitizer for generating positional data corresponding to the circumference of one of a lens and a lens pattern positioned on said detecting surface;
a central processing unit operably associated with said digitizer, said central processing unit for receiving the positional data from said digitizer; and
an instruction set for processing the positional data into trace data usable by an edger device.

2. The shape capture system of claim 1, wherein said position indicator is a stylus incorporating a collar, said collar surrounding said stylus and said collar maintaining said stylus substantially perpendicular to said coordinate detecting surface when a first end of said collar is flush with said coordinate detecting surface.

3. The shape capture system of claim 2, wherein said collar is cylindrical.

4. The shape capture system of claim 2, wherein said collar further comprises a slot for receiving a stylus having a toggle button.

5. The shape capture system of claim 1, further comprising a storage medium for storing the trace data.

6. The shape capture system of claim 1, further comprising a patternless edger device.

7. The shape capture system of claim 1, further comprising a second input device operably associated with said central processing unit.

8. The shape capture system of claim 7, wherein said second input device is selected from the group consisting of a keyboard, a mouse, a second digitizer having a position indicator, and a puck.

9. The shape capture system of claim 8, further comprising a display operably associated with said central processing unit, said display for displaying at least one of shape data and trace data.

10. A method for determining shape data of one of a lens and a lens pattern, comprising the steps of:
providing a digitizer having a position indicator and a coordinate detecting surface;
positioning one of a lens and a lens pattern on the coordinate detecting surface;
generating positional data by tracing with the position indicator around one of the lens and the lens pattern on the coordinate detecting surface; and
processing the positional data into trace data usable by an edger device.

11. The method of claim 10, further comprising the steps of:
providing an edger device; and
communicating the trace data to the edger device; and
edging a lens blank to a shape corresponding to the communicated trace data.

12. The method of claim 11, including the step of providing a patternless edger device.

13. The method of claim 10, wherein the position indicator is a stylus having a tip, the stylus cooperating with the detecting surface for generating positional data of the tip when the tip is within a predetermined proximity of the detecting surface.

14. The method of claim 13, including the further steps of:
providing a collar partially surrounding the stylus and proximate the tip, the collar causing the stylus to generate positional data only if an end of the collar proximate the tip is substantially flush with the detecting surface and the stylus is substantially perpendicular to the detecting surface; and
maintaining the stylus substantially perpendicular to the detecting surface during said tracing step.

15. The method of claim 10, further comprising the steps of:
providing an input device operably associated with the central processing unit; and
providing a display operably associated with, the central processing unit.

16. The method of claim 15, including the step of displaying the shape of one of the lens and the lens pattern on the display.

17. The method of claim 16, including the step of rotating the displayed shape on the display using the input device.

18. The method of claim 16, including the step of changing the circumference of the displayed shape on the display using the input device.

19. The method of claim 16, including the step of changing the orientation of the displayed shape on the display using the input device.

20. The method of claim 10, including the step of storing the trace data in a storage medium.

21. A method for processing shape data from a lens, comprising the steps of:
capturing a lens image having a circumference;
calculating a center point of the image;
calculating spaced radii values from the center point to the circumference;
calculating smoothed radii values derived from the spaced radii values; and
converting the smoothed radii values into trace data usable by an edger.

22. The method of claim 21, including the step of providing a digitizer operably associated with a stylus for said capturing step.

23. The method of claim 22, including the step of providing a stylus having a collar.

24. The method of claim 23, comprising the further step of mathematically compensating the calculated smoothed radii values to account for the diameter of the collar.

25. The method of claim 21, including the step of converting the smoothed radii values using a calibration routine.

26. The method of claim 21, comprising the further step of displaying the shape of the image on a display.

27. The method of claim 21, comprising the further step of saving trace data to a computer memory.

28. The method of claim 21, comprising the further step of transferring trace data to the edger for edge processing a lens blank.
